(19) United States
(12) Patent Application Publication
(10) Pub. No.: US 2008/0030072 A1
(43) Pub. Date: Feb. 7, 2008

(54) Method and apparatus for positioning a reservoir-mounted component

(76) Inventors: Thomas S. Legeza, Olmsted Township, OH (US); Craig S. Haehn, Avon Lake, OH (US)

Correspondence Address: CALFEE HALTER & GRISWOLD, LLP, 800 SUPERIOR AVENUE, SUITE 1400, CLEVELAND, OH, 44114, US

(21) Appl. No.: 11/498,641

(22) Filed: Aug. 3, 2006

(51) Int. Cl. B60T 13/74

(52) U.S. Cl. 303/139; 303/3

(57) ABSTRACT

An improved configuration for a vehicle system having a brake system component mounted to an air reservoir and an apparatus for positioning or leveling the brake system component relative to a reference point. The apparatus may include a first end portion having one or more contact points for engaging the reservoir along a curved surface and a second end portion positioned proximate to the component. The apparatus being adapted resist relative movement between the component and the reservoir.

### BACKGROUND OF THE INVENTION

Commercial vehicles, such as for example tractor-trailers, may utilize an anti-lock brake electronic control unit (ABS ECU) to control braking on air-braked heavy duty trailers, semi-trailers and dollies. To conserve space on the vehicle, the electronic control unit may be mounted onto a compressed air reservoir in the vehicle's brake system. For example, the electronic control unit and a valve assembly may be integrated into a single, self-contained unit or module that may mount to the supply port of the air reservoir, via a nipple, for example. Directly mounting the module to the reservoir in this manner is beneficial because it reduces the number of pneumatic lines and/or electrical wiring required and it avoids using space on the truck rail/frame, which truck manufacturers prefer since space on the rail/frame is limited.

Trailer roll stability systems are also available for use on commercial vehicles. These systems may utilize a lateral acceleration sensor to determine if the trailer's lateral force is high enough to cause instability. Based on the lateral acceleration information and other factors, a roll stability system controller may be utilized to automatically intervene to regain stability. The lateral acceleration sensor must typically be mounted in a specific orientation in order to provide accurate acceleration readings. For example, a lateral acceleration sensor may need to be mounted substantially horizontal as measured on level ground. Therefore, lateral acceleration sensors are often mounted on the vehicle frame to control their position.

Today's trailer roll stability systems typically utilize the ABS ECU as the system controller to execute the system's control logic. In order to achieve adequate roll stability control, most trailer roll stability system modules are configured to control the brakes on the left and right side of the trailer independently. Thus, known modules include two controllers and two relay valves, one for each side of the trailer. Due to the additional hardware, these two-channel modules are considered too heavy to nipple-mount to the service air reservoir. Thus, the ABS ECU, when used in conjunction with the trailer toll stability system, must be frame or rail mounted.

Providing a trailer roll stability module that may mount to a compressed air reservoir on a vehicle is desirable. Further, incorporating a lateral acceleration sensor with the module and providing an apparatus to ensure the sensor is properly positioned is also desirable.

### SUMMARY

The present invention relates generally to vehicle air brake systems. In particular the present invention relates to an improved system configuration in which a brake system component brake system component mounted to an air reservoir.

In accordance with one inventive aspect, a brake system component is provided which may mount to the air reservoir and an apparatus is provided for positioning or leveling the brake system component relative to a reference point. In one embodiment, the brake system component may be an electronic control module, such as a antilock brake electronic control unit or a trailer roll stability system controller. The apparatus may be a bracket that mounts to the module such that a portion of the apparatus engages the reservoir to resist rotation undesired movement of the module relative to the reservoir.

In accordance with another aspect of the invention, an apparatus is provided to aid in the positioning of a lateral acceleration sensor. In one embodiment, the lateral acceleration sensor is mounted onto a brake system component and the apparatus resists undesired movement of the brake system component. In a more specific embodiment, the brake system component is a trailer roll stability module and the lateral acceleration sensor is mounted onto a printed circuit board used in the module. In still a further embodiment, the trailer roll stability module is mounted onto a compressed air reservoir and the apparatus resists relative movement between the module and the reservoir.

In accordance with another aspect of the invention, a trailer roll stability system control module is provided, which may nipple mount to a compressed air reservoir. In one embodiment, the trailer roll stability module is configured as a single channel unit and includes a lateral acceleration sensor. A leveling device may be included to ensure that the lateral acceleration sensor remains properly positioned relative to a reference point.

Further aspects and concepts will become apparent to those skilled in the art after considering the following description and appended claims in conjunction with the accompanying drawings.

### BRIEF DESCRIPTION OF THE DRAWINGS

In the accompanying drawing, which are incorporated in and constitute a part of the specification, embodiments of the invention are illustrated, which, together with a general description of the invention given above, and the detailed description given below, serve to exemplify embodiments of the invention:

FIG. 1 is a perspective view of a component mounted to a reservoir according to one embodiment of an apparatus illustrating principles of present invention;

FIG. 2 is a side view of the component mounted to the reservoir of FIG. 1;

FIG. 3 is a front view of the component mounted to the reservoir of FIG. 1;

FIG. 4 is a partial sectional perspective view of the component mounted to the reservoir of FIG. 1;

FIG. 5 is a perspective view of an exemplary embodiment of a positioning apparatus illustrating the principles of the present invention; and

FIG. 6 is a perspective view of a second exemplary embodiment of a positioning apparatus illustrating the principles of present invention.

### DETAILED DESCRIPTION

While various aspects and concepts of the invention are described and illustrated herein as embodied in combination in the exemplary embodiments, these various aspects and concepts may be realized in many alternative embodiments, either individually or in various combinations and sub-combinations thereof. Unless expressly excluded herein all such combinations and sub-combinations are intended to be within the scope of the present invention. Still further, while various alternative embodiments as to the various aspects and features of the invention, such as alternative materials, structures, configurations, methods, devices, software, hardware, control logic and so on may be described herein, such descriptions are not intended to be a complete or exhaustive list of available alternative embodiments, whether presently known or identified herein as conventional or standard or later developed. Those skilled in the art may readily adopt one or more of the aspects, concepts or features of the invention into additional embodiments within the scope of the present invention even if such embodiments are not expressly disclosed herein. Additionally, even though some features, concepts or aspects of the invention may be described herein as being a preferred arrangement or method, such description is not intended to suggest that such feature is required or necessary unless expressly so stated. Still further, exemplary or representative values and ranges may be included to assist in understanding the present invention however, such values and ranges are not to be construed in a limiting sense and are intended to be critical values or ranges only if so expressly stated.

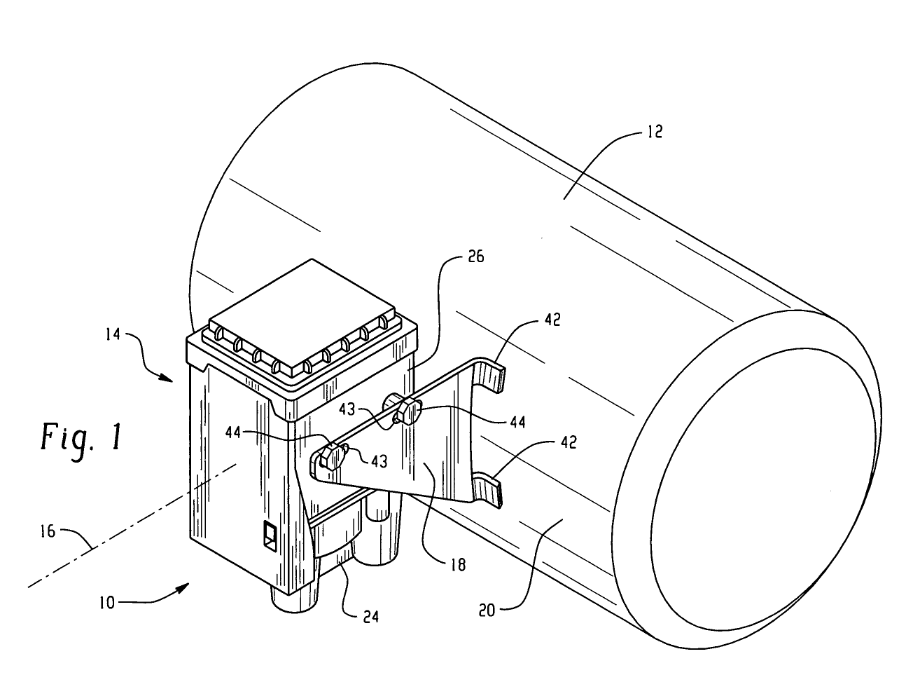

FIGS. 1-3 illustrate a portion of an antilock brake system of a commercial vehicle. The system 10 may include an air reservoir 12 for storing compressed air, a brake system component 14, such as for example an electronic control module, which may be mounted to the reservoir along an axis 16, and an apparatus 18 for aiding the proper positioning of the component 14 relative to a reference point, such as for example level ground or the reservoir 12. The apparatus 18 may aid in establishing a position of the component 14 relative to the reference point, and/or may aid in maintaining the position of the component relative to the reference point.

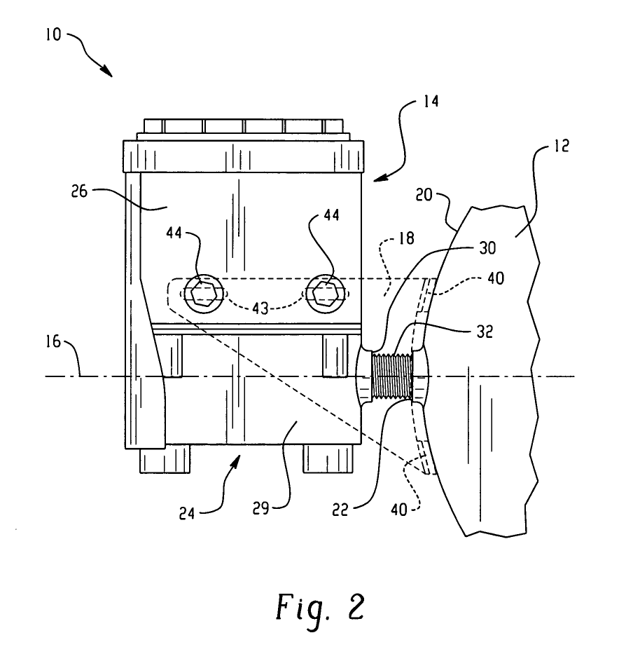

The air reservoir 12, as illustrated in FIG. 1, is configured to store a supply of compressed air for use in the air brake system 10 of the vehicle. The reservoir 12 may have a generally cylindrical configuration with a curved outer side surface 20, as is known in the art. Other configurations of the air reservoir 12, however, are possible. As shown in FIG. 2, the air reservoir 12 may include a supply port 22 located on the side surface 20. The supply port 22 may include a female thread for facilitating connection with a pneumatic line or a component of the brake system.

In the exemplary embodiment of FIGS. 1-4, the brake system component 14 may be realized as an electronic control module. The electronic control module 14 may include a valve portion 24, such as a modulator relay valve, and an electronic control unit portion 26, such as an anti-lock brake system electronic control unit (ABS ECU). The electronic control unit portion 26 may include a lateral acceleration sensor 27. In one embodiment, the lateral acceleration sensor 27 may be mounted to or integrated with a printed circuit board 28 used by the control unit portion 26. The lateral acceleration sensor 27 may be mounted on the circuit board by any appropriate method, such as for example, soldering, as is known in the art.

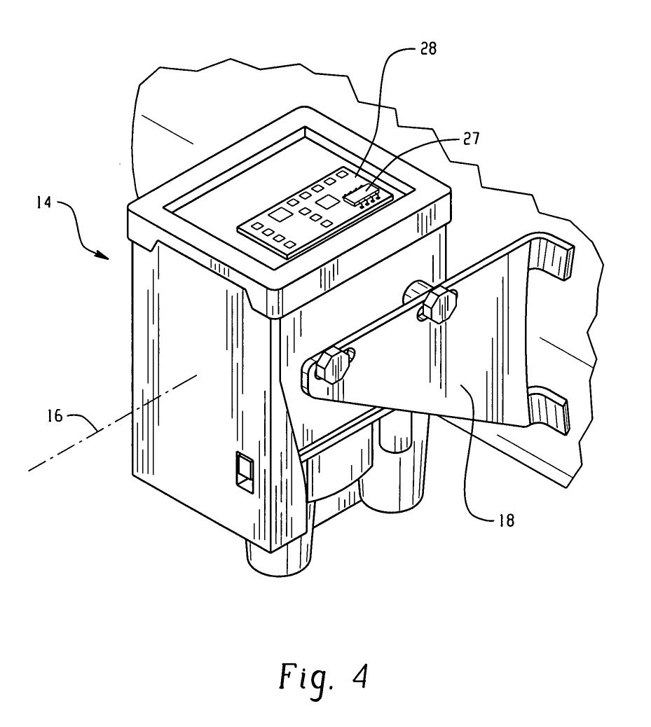

Vehicle roll stability systems, such as for example the Bendix® Trailer Roll Stability Program (TRSP), may utilize a lateral acceleration sensor to monitor the lateral forces on the vehicle. The electronic control module 14 and the lateral acceleration sensor 27 may, therefore, be components in a vehicle trailer roll stability system. The accuracy of a lateral acceleration sensor is dependent, in part, on being positioned substantially horizontal as measured relative to level ground. Thus, to obtain an accurate lateral acceleration reading, the lateral acceleration sensor 27 in FIG. 4 is positioned and maintained such that the angle θ, as shown in FIG. 4, is kept small or zero, such as for example within about ±5 degrees of horizontal as measured from level ground.

In the embodiment of FIGS. 1-4, the printed circuit board 28, when installed in the module 14, resides along a top portion of the module. When the module 14, is mounted to the reservoir 12, the installer should ensure that the printed circuit board 28 and lateral acceleration sensor 27 are horizontal.

The valve portion 24 may include a valve body 29 and a supply port 30. The supply port 30 may include female threads for facilitating connection with the air reservoir 12 or another brake system component. The valve portion 24 may be an electro-pneumatic control valve, such as a modulator relay valve, for precisely modifying the brake pressure on command.

As shown in FIG. 2, the electronic module 14 may mount to the air reservoir 12 via a nipple 32, such as ¾″ NPT nipple, threaded between the reservoir supply port 22 and the module supply port 30. The electronic module 14, however, may mount to the reservoir 12 by any suitable means.

The threaded connection between the module 14 and reservoir 12, however, may allow the module, and lateral acceleration sensor 27, to be improperly positioned. For example, a technician during maintenance on the vehicle might inadvertently rotate the module 14 to a position where the lateral acceleration sensor 27 is not substantially horizontal. Further, if the current module 14 is replaced, the new module might not be properly positioned when installed. As a result, the trailer roll stability system may not function properly.

Since the lateral acceleration sensor 27 may be mounted on the module 14, a means may be provided for aiding the initial positioning of the component and in maintaining the component in a position that allows the lateral acceleration sensor to function accurately. The apparatus 18, as described herein, may provide this function. The exemplary embodiment of the apparatus 18 illustrated in FIGS. 1-3, may be used as both a guide during installation of the module onto the reservoir and as a device for maintaining the component 14 substantially in position relative to the reservoir 12 so that the position of the lateral acceleration sensor 27 is not substantially disturbed.

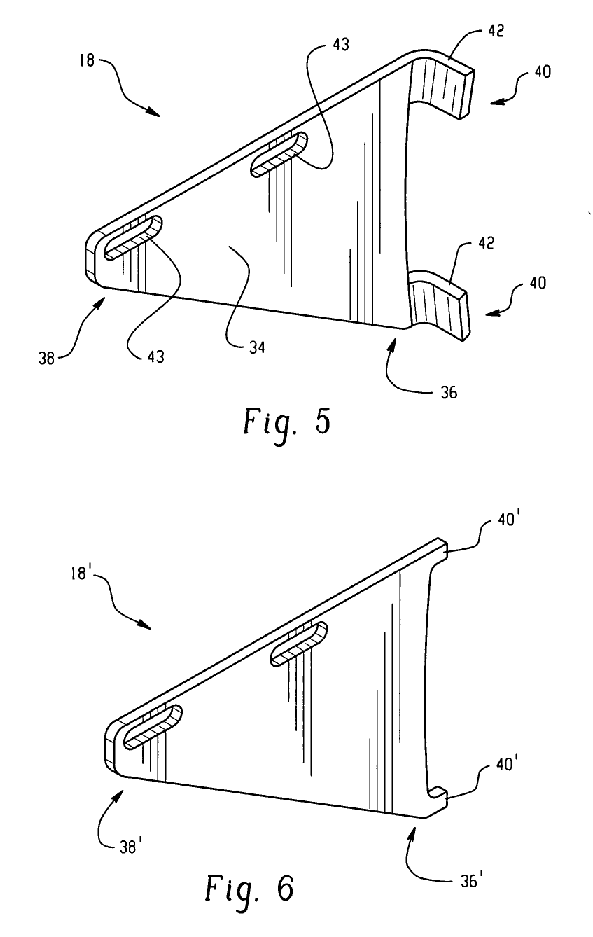

FIG. 5 is a perspective view of an exemplary embodiment of the apparatus 18. The apparatus 18 may be configured as a thin plate having two substantially parallel side faces 34, a first end portion 36, and a second end portion 38 The apparatus 18, however, may be configured in a variety of ways. The first end portion 36 may include one or more reservoir contact points or areas 40. In the embodiment of FIG. 2, the contact points or areas 40 are located on two tabs 42 extending generally perpendicular relative to the side faces 34 of the apparatus 18. However, any configuration of the contact points 40 that aid in aligning and maintaining the position of the reservoir mounted component 14 are possible.

The second end portion 38 may fixably connect to the first end portion 36. For example, the first and second end portions 36, 38 may be formed as a single, rigid component. The second end portion 38 is configured to interface with the component 14 and may include one or more mounting openings 43. The mounting openings 43 may be configured to receive fasteners 44 for mounting the apparatus 18 to the module 14, such as for example via mounting holes 45 in the module. The second end portion 38, however, may be configured in a variety of ways. For example, the apparatus 18 may attach to the component 14 by any suitable means or the apparatus may be configured to attach to the reservoir 12 while utilizing an interfacing portion to block rotation of the reservoir mounted component.

The apparatus 18 may be made from a variety of rigid materials. For example, the apparatus 18 may include metal, such as aluminum or stainless steel, glass reinforced plastic, or other similar materials.

Referring to FIG. 2, when the module 14 is threadably mounted to the reservoir 12 via the nipple 32, the apparatus 18 may mount to the module 14 via the fasteners received through the opening 43. The mounting openings 43 may be formed as slots that allow the apparatus 18 to be adjustably moved into contact with the reservoir 12. In this position, the contacts points 40 on the apparatus 18 engage the reservoir 12 along its curved surface 20. As shown in FIG. 2, the surface of the reservoir 18 extends between the contact points 40 when the apparatus 18 is moved into position. Thus, any attempted rotation of the apparatus 18 and module 14 about the axis 16 is restricted by the engagement between of the reservoir surface 20 and the contact points 40.

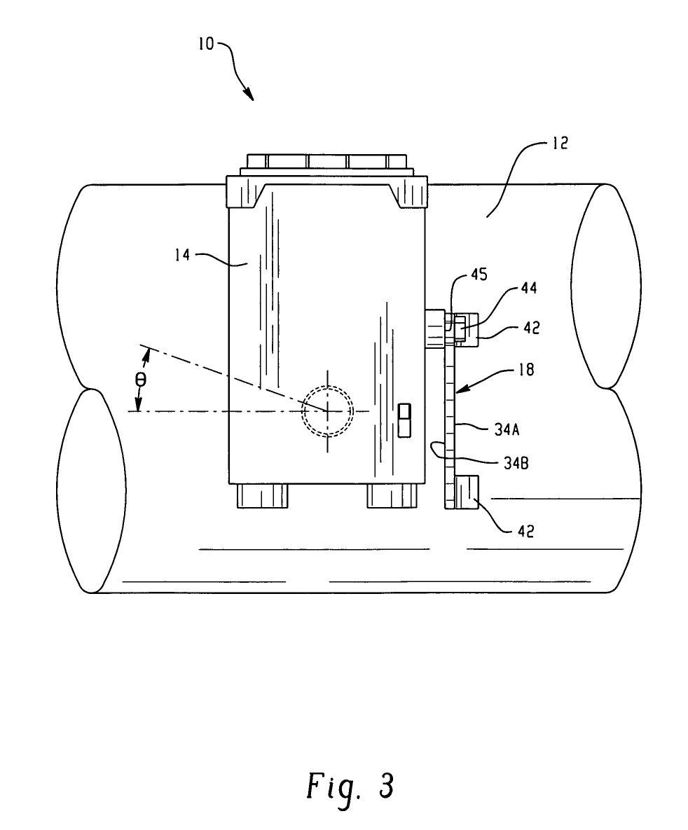

FIG. 6 illustrates a second exemplary embodiment of the apparatus according to the principles of the present invention. The apparatus 18′ is substantially similar to the apparatus 18 of FIG. 3 in that it includes a first end portion 36 including one or more reservoir contact points or areas 40′ and a second end portion 38′ for interfacing with the component 14. In the apparatus of FIG. 4, however, the configuration of the contact points differs from the apparatus 18 of FIG. 3 in that it does not include the tabs 42. Instead, the contacts points 40′ extend axially from the apparatus 18′.

The invention has been described with reference to the preferred embodiments. Modification and alterations will occur to others upon a reading and understanding of this specification. It is intended to include all such modifications and alterations insofar as they come within the scope of the appended claims or the equivalents thereof.

1. An apparatus for positioning a brake system component mounted to a compressed air reservoir on a commercial vehicle, the apparatus comprising:
a first end portion positioned proximate to the reservoir, the first end portion including one or more contact points for engaging the reservoir along a curved surface;
a second end portion positioned proximate to the component, wherein the component includes an electronic control unit for controlling a roll stability function on the vehicle, the second end portion being fixed relative to the first end portion, the second end portion adapted to engage the component to impede movement of the component relative to the reservoir.

2. The apparatus of claim 1 wherein the second end fixably attaches to the component.

3. The apparatus of claim 1 wherein the second end attaches to the component via one or more fasteners.

4. The apparatus of claim 1 wherein the component threadably mounts to the reservoir.

5. The apparatus of claim 1 wherein the electronic control unit includes a lateral acceleration sensor.

6. The apparatus of claim 1 further comprising two substantially parallel side faces, wherein the one or more contact points reside on one or more tabs extending substantially perpendicular to the side faces.

7. The apparatus of claim 5 wherein the lateral acceleration sensor resides on a printed circuit board for use in the electronic control unit.

8. The apparatus of claim 5 wherein impeding movement of the component relative to the reservoir maintains the lateral acceleration sensor within the range of about ±5 degrees from horizontal measured relative to level ground.

9. A leveling device for a trailer roll stability module that is mounted to a compressed air reservoir on a commercial vehicle, the leveling device comprising:
a first end portion positioned proximate to the reservoir, the first end portion including a means for engaging a surface of the reservoir; and
a second end portion for attaching to the trailer roll stability module;
wherein the means for engaging a surface of the reservoir impedes movement of the trailer roll stability module relative to the reservoir.

10. The leveling device of claim 9 wherein the trailer roll stability module includes a lateral acceleration sensor.

11. The leveling device of claim 10 wherein the lateral acceleration sensor resides on a printed circuit board installed in the trailer roll stability module.

12. The leveling device of claim 9 wherein the one or more contact points engage the reservoir along a curved outer surface.

13. The leveling device of claim 9 wherein the trailer roll stability module threadably mounts to the compressed air reservoir.

14. The leveling device of claim 9 wherein the second end portion attached to the trailer roll stability module by one or more fasteners.

15. The leveling device of claim 9 wherein the means for engaging a surface of the reservoir prevents relative rotation between the roll stability module and the reservoir of greater than about 5 degrees of rotation.

16. A positioning apparatus for a reservoir mounted trailer roll stability module, comprising:
a body portion having a generally plate-like configuration;
a first end portion including at least two contact points that engage a compressed reservoir along a curved outer surface; and
a second end portion attached to the trailer roll stability module;
wherein movement of the trailer roll stability module relative to the reservoir is restricted by engagement between the reservoir and the at least two contact points.

17. An anti-lock brake system for a commercial vehicle, the system comprising:
a compressed air reservoir;
an electronic module mounted to the air reservoir for controlling a roll stability function on the vehicle, the electronic module including a lateral acceleration sensor; and
an apparatus associated with the electronic module for impeding relative rotation between the electronic module and the reservoir, wherein the apparatus includes a plurality of contact points that engage the reservoir along a curved surface.

18. The system of claim 17 wherein the electronic module threadably mounts to the air reservoir.

19. The system of claim 17 wherein the lateral acceleration sensor resides on a printed circuit board installed in the electronic module.

20. The system of claim 17 wherein the apparatus prevents greater than about 5 degrees of relative rotation between the module and the reservoir.

21. The system of claim 17 wherein the electronic module includes a valve portion and an electronic control unit portion for controlling a trailer roll stability function.

22. The system of claim 17 wherein the apparatus fixably attaches to the electronic module.

23. A method for aiding the proper positioning of a lateral acceleration sensor of a trailer roll stability system on a commercial vehicle, the method comprising:
integrating the lateral acceleration sensor into an electronic module, wherein the module controls a trailer roll stability function on the vehicle;
mounting the electronic module onto an compressed air reservoir such that the lateral acceleration sensor is positioned substantially horizontal as measured by level ground; and
restricting greater than about 5 degrees of relative rotation between the electronic module and the reservoir.

24. The method of claim 23 wherein integrating the lateral acceleration sensor into an electronic control module further comprises:
mounting the lateral acceleration sensor onto a printed circuit board.

25. The method of claim 23 wherein restricting greater than about ±5 degrees of relative rotation between the electronic module and the reservoir further comprises:
attaching a positioning apparatus to the module; and
engaging the positioning apparatus with the reservoir.

26. The method of claim 25 wherein the positioning apparatus engages the reservoir along a curved outer surface of the reservoir.

27. The method of claim 25 wherein the positioning apparatus comprising a plurality of contact points for engaging the reservoir.

28. The method of claim 23 wherein the electronic module includes a valve portion and an electronic control unit portion.
